(19) United States
(12) Patent Application Publication
(10) Pub. No.: US 2009/0106097 A1
(43) Pub. Date: Apr. 23, 2009

(54) METHOD OF PROMOTING CHARITIES USING CUSTOMIZED JEWELRY

(76) Inventor: Trudy Schwartz-Burrill, San Pedro, CA (US)

Correspondence Address: TROJAN LAW OFFICES, 9250 WILSHIRE BLVD, SUITE 325, BEVERLY HILLS, CA, 90212, US

(21) Appl. No.: 11/876,569

(22) Filed: Oct. 22, 2007

(51) Int. Cl. G06Q 30/00

(52) U.S. Cl. 705/14

(57) ABSTRACT

The present invention involves a method of promoting a cause of any charity or cause via personalized jewelry. The method comprises the following steps: (1) creating a personal jewelry item incorporating an intriguing generic symbol not associated with any specific organization; (2) providing said jewelry item to a person who desires to promote a specific charity; (3) instructing said person to associate said symbol with the charity of their choice; (4) displaying said jewelry in the presence of others in order to solicit inquiries concerning the jewelry inspired by the symbol; (5) responding to said inquiries by others by communicating information about the charity; whereby the cause of the charity is promoted.

### FIELD OF THE INVENTION

The invention relates generally to a method of promoting charities and various public causes.

### BACKGROUND OF THE INVENTION

There are several ways for charities and public causes to attract attention of potential supporters. One way is to seek an endorsement from a celebrity who would then spread the message in the press and at public appearances. Another way is to engage in mass mailings and advertisement using the tools developed by commercial enterprises. Yet another way is to organize sporting events, fairs or festivals where attendees have a chance to pick up information about the charity. Yet another way is to license names and symbols for placement on commercial products, including free promotional items, such as pens, cups and plastic sacks. In addition to placing their symbol on the licensee's product, the charities also include contact information in the hopes that a purchaser of a box of cereal or a carton of orange juice would be intrigued and, for example, follow the link to the Internet website to learn more.

Each of the above methods is effective in their own way. However, the above methods share the same drawback: they lack personal interaction and rely on passive exposure of the public to the organization's message. A way of having personal interaction with potential supporters is limited to making unsolicited phone calls and hiring promoters. The promoters attempt to get attention of pedestrians, shoppers and attendees of public events, where a charity may rent a booth or a table. The work of such promoters is often frustrating and unproductive. Most people instinctively avoid promoters for the fear of being shamed into giving money or simply of becoming trapped in a lengthy lecture. Only occasionally would someone voluntarily initiate a contact with a promoter and request information about the charity that he or she represents.

It would therefore be desirable to have a method of spreading a charity's message via a person-to-person interaction where potential supporters would be enticed to voluntarily seek information about the charity from the promoter. It would be even more advantageous to enable people not only to support the charity, but also to spread its message further to other potential supporters. The present invention addresses these needs in several ways.

### SUMMARY OF THE INVENTION

The present invention involves a method of promoting a cause of any charity or cause via personalized jewelry. The method comprises the following steps: (1) creating a personal jewelry item incorporating an intriguing generic symbol not associated with any specific organization; (2) providing said jewelry item to a person who desires to promote a specific charity; (3) instructing said person to associate said symbol with the charity of their choice; (4) displaying said jewelry in the presence of others in order to solicit inquiries concerning the jewelry inspired by the generic symbol; (5) responding to said inquiries by others by communicating information about said charity; whereby the cause of the organization is promoted.

### DESCRIPTION OF THE DRAWING

FIG. 1 is a flowchart of the method of the present invention.

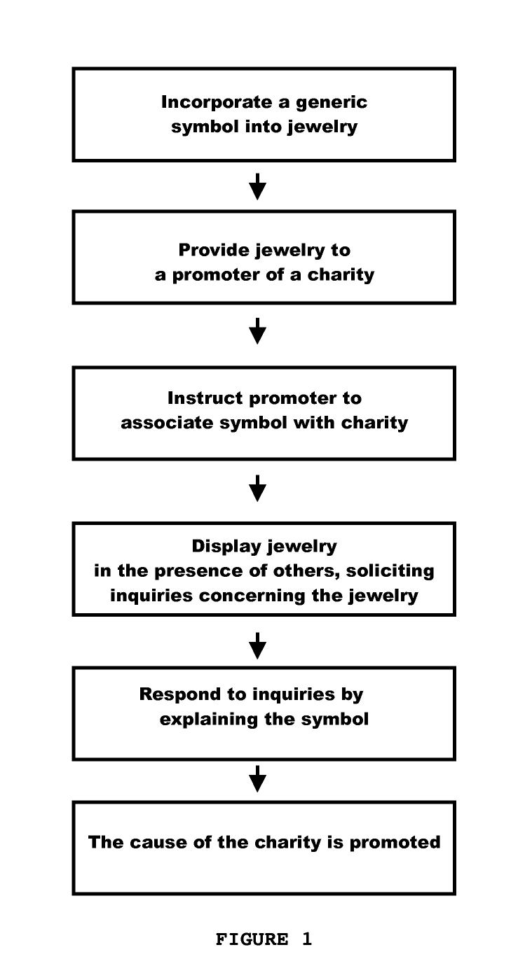

### DETAILED DESCRIPTION OF THE INVENTION

Promoting a charity through a person-to-person interaction is a good way of spreading the message. Although a series of one-on-one contacts does not reach as far and wide as a mass mailing campaign, such interactions are more likely to be productive. The recipient of the message is more likely to become involved and spread the message further. When such potential recipients are selected randomly, a promoter of the charity needs a method of attracting their attention. Ideally, the potential recipient would be so intrigued that he or she would approach the promoter voluntarily and start asking questions.

Personal adornments are a great way to attract attention. For example, yellow rubber wristbands have become associated with Livestrong Foundation, a charity started by the bicyclist Lance Armstrong to raise money for cancer research and treatment. Sold for only a dollar, the wristbands are less a source of revenue than a way to raise awareness of the charity's cause. Following the Livestrong example, many other charities chose their own colors and started distributing similar wristbands.

Personal jewelry items often attract attention in intimate settings, conducive of conversations. A piece of jewelry that is capable of being a “conversation piece” may be used to direct the conversation to the topic of a charity or a cause that the wearer wishes to promote. The jewelry would take over a difficult task of starting such conversation. Furthermore, the interaction will be initiated by the potential supporter, not by the promoter of the charity, thus assuring the potential supporter's attention.

Personal jewelry, such as rings, bracelets, brooches, pendants and earrings can be easily personalized. The personalization may include, for example, an engraving of letters, words, dates or symbols. Alternatives to engraving are stone inlays and similar artwork known in the art of jewelry making.

The method of the present invention involves the first step of making a jewelry item incorporating a generic symbol. The generic symbol is such that it arouses curiosity. Examples of symbols may be a letter “Y”, a question mark, or any other symbol likely to intrigue an observer. The generic symbol is meant to fit the overall look of the jewelry item, so as to make it more attractive to a potential buyer. Thus a single distributor may use one or more generic symbols and place them on various rings, pendants, earrings, brooches or sets of matching jewelry pieces. Optionally, the buyer may design or have designed a custom generic symbol that would fit the purpose specified above.

The jewelry with the generic symbol is then presented to a person who wishes to promote a charity. One way of reaching out to such persons may be through advertising targeted to fundraising professionals. Alternatively, the jewelry with generic symbols may be sold to individuals through usual jewelry distribution channels.

The wearer of the jewelry is instructed to use jewelry to promote a charity. To do that, the wearer of the jewelry is instructed to associate the generic symbol with the charity of his or her choice.

The jewelry with the symbol is then worn in the presence of others so as to solicit inquiries about the jewelry. A person wearing the jewelry responds to the inquiries by providing information about the charity. The responses should inspire interest in the charity in the inquiring party. To assist with such responses, personalized jewelry may come with a guide on the main points to be made in the response. The guide may be for example, a wallet-size card or a pocket-size electronic device. The guide may either contain fixed information, or give the user an opportunity to make his or her own input and memorialize essential facts about the charity of choice. Optionally, the wearer of the jewelry may wish to give away printed information or other small mementos of the conversation with the inquiring person.

### EXAMPLE 1

The practitioner of the method may create a finger ring with a surface having a large engraved “Y” prominently displayed on it. The purchaser of the ring would be interested in promoting a Thanksgiving toy drive. The purchaser would associate the Y with the toy drive. The ring will be worn at a social event where persons likely to contribute may be present. At the event, one or more attendees would be intrigued by the unusual engraving and ask whether it means anything. The wearer would respond that he or she is promoting a toy drive and how to contribute to the drive. The inquiring person would thus receive the information necessary to support the charity should he or she wish to do so.

The method of the present invention may also provide an Internet website where the purchasers of customized jewelry of the present invention may submit and exchange tips on promoting charities. The website may include a section or a link dedicated to each charity being promoted through this method. The inquiring persons may be invited to visit the website in order to get more information and become involved in the charity's cause.

The method of the present invention is described in relation to a charity. By the word “charity” the inventor means to encompass any non-profit organization or a public cause that needs promotion. This may include any neighborhood, local, national or a worldwide organization or cause.

While the invention is described in connection with the examples, the examples are not intended to be limiting. It is intended to cover all alternative modifications and equivalents of the method that may be included in the spirit and the scope of the invention as defined by the appended claims.

What is claimed is:

1. A method of promoting a charity or a public cause comprising the steps of:
creating an item of jewelry that incorporates a generic symbol;
providing said item of jewelry to a person who desires to promote a charity;
instructing said person to associate said symbol with a charity;
displaying said item of jewelry in the presence of others in order to solicit inquiries;
responding to said inquiries by others by communicating about said charity;
whereby said charity is promoted.

2. The method of claim 1, further providing a selection of generic symbols.

3. The method of claim 1, further comprising a step of providing artistic design services in connection with said generic symbol.

4. The method of claim 1, further comprising a step of providing a guide for assisting in said response to inquiries.

5. The method of claim 4, wherein said guide is printed medium.

6. The method of claim 4, wherein said guide is electronic memory device.

7. The method of claim 4, wherein said guide contains fixed information.

8. The method of claim 4, wherein said guide has means of creating customized information.

9. The method of claim 1, further comprising a step of providing an Internet website for assisting with promoting charities.
